(19) United States
(12) Patent Application Publication
(10) Pub. No.: US 2025/0017808 A1
(43) Pub. Date: Jan. 16, 2025

(54) WALKING FRAME WITH SEAT AND BACKREST

(71) Applicant: John Ing Ching Tang, Sibu (MY)

(72) Inventor: John Ing Ching Tang, Sibu (MY)

(21) Appl. No.: 18/751,260

(22) Filed: Jun. 23, 2024

(30) Foreign Application Priority Data
Jun. 24, 2023 (MY) PI2023003832

(51) Int. Cl. A61H 3/04

(52) U.S. Cl. CPC A61H 3/04

(57) ABSTRACT

A cantilever wheeled walking frame with a seat that is connected to the front of the frame by a centrally located anterior-posterior horizontal beam. The user approaches the walking frame from behind and walks with the beam between his lower limbs and with his buttock on the seat to prevent him from falling. A front controlled mechanical backrest is also disclosed. Both the heights of the seat and the backrest may be adjustable.

### TECHNICAL FIELD

The objective of the present invention is related to a walking frame. More specifically, it has wheels, a height adjustable seat and a backrest.

### BACKGROUND ART

The walking frame is a common mobility aid for people with walking disability. To further enhance mobility functions, there are walking frames with castor wheels, with or without their corresponding braking accessories. The walking frame can be made even more versatile by the addition of a seat affixed proximally to the frame, so that when the user is tired, he can turn himself or the frame around to sit on it and use the front part of the frame as backrest. Additionally, as there is still a possibility of fall when using the walking frame, straps, slings and cushions are often used to tie various parts of the user's body onto fixtures on the frame, involving cumbersome and tight straps and slings at the chest and the waist. We need a walking frame with a height adjustable seat that can be aligned to the level of the platform that the user is sitting on (so that he needs only to slide forward or backward to and fro the seat) and a frame that prevents him from falling while walking, all with minimal or without the use of straps or slings in the processes.

### SUMMARY OF THE INVENTION

To fully appreciate the present invention, it is emphasized that as human walks with two legs, a narrow horizontal beam in between his lower limbs, especially at upper thighs, will not hinder his gait. The present invention provides a wheeled walking frame with a cantilever seat that is attached by a horizontal beam extending anterior-posteriorly from the front of the frame. The user approaches the walking frame from behind to sit on the seat and walks with the beam in between his two lower limbs. While he is walking, he can rest his buttock on the seat any time or if he prefers, sit and walk at the same time (much like pedalling). The seat and the horizontal beam, at an appropriate height, thereby support the user with weak lower limbs while still allow him to walk with his two feet. The height of the seat can be adjusted to match the user's height to allow comfortable walking, and to level the seat to the height of the platform that he intends to transfer to and fro. In this way he can just slide his buttock forward onto the seat and backward to leave the seat. Various height adjusting means, such as hydraulic jack, actuator or manual rotating/swinging height adjusting shaft can be used for this purpose. The present invention also provides the walking frame with a novel backrest in the form of brackets comprising rotatable handles in front and a transvers bar at the back on each side of the frame. Rotating the handles in one direction will open the brackets to allow the user to enter or exit the brackets, while in another direction secure the user inside the brackets. The brackets may have cushions for comfort or gripping means for his or her caregiver to push him around. Though the backrests are specifically designed for the present invention, they may be used in other industries, such as other personal mobility devices like scooters or wheelchairs. The rotating movements of the brackets may be powered by other means, such as an electric motor.

In yet another embodiment, the walking frame has large front wheels with corresponding handrails for the user to push to move around. There are also foot pedals provided so that the walking frame can turn into a wheelchair, which can both be manual or motorized.

Both the horizontal beam, the seat, and the backrest may be presented as detachable accessories for regular walking frames to achieve the above-mentioned benefits.

### BRIEF DESCRIPTION OF THE DRAWINGS

FIG. 1 is a back perspective view of a preferred embodiment, wherein there is a wheeled cantilever walking frame 1, and its components 2 to 10, that is attached 15 to a seat 11, and its respective components 12 to 24.

FIG. 1a is a close-up perspective view of the attachment 15 between the components of the frame 1 and the components of the seat 11.

FIG. 2 is a front perspective view of the walking frame as shown in FIG. 1.

FIG. 3 is a back perspective view of the walking frame as shown in FIG. 1, wherein the backrest's brackets 24 are closed and the seat 11 and its components 12 to 24 are elevated.

FIG. 4 is a back perspective view of another preferred embodiment comprising big front wheels 32 with their corresponding handrails 31 for manual pushing by the user.

FIG. 5 is a back perspective view of a regular walking frame with the seat 11 and the brackets 24 attached.

FIG. 6 is a front perspective view of the embodiment in FIG. 5 wherein the brackets 24 are closed.

### DETAILED DESCRIPTION OF PREFERRED EMBODIMENTS

The present invention provides a novel walking frame 1 with a horizontal beam 12 and a seat 11 to allow the user to sit, walk, or concurrently sit-walking, all done with the beam 12 in between his two lower limbs. It is further provided with brackets 24 that encircle the user's torso. Such novel configuration essentially eliminates the risk of falling, as the beam 12 and the seat 11 prevent falling straight down while the brackets 24 prevent falling sideways or backward, thereby making it useful for daily living, for gait training and rehabilitation of users with weak or unstable lower limbs. Additionally, the height of the seat 11 (with the brackets 24) with respect to the frame 1 are adjustable to ease transfer to and fro the seats 11 across various platforms of different heights, and to optimize the level of the beam 12 between the user's thigh for him/her to walk and sit comfortably.

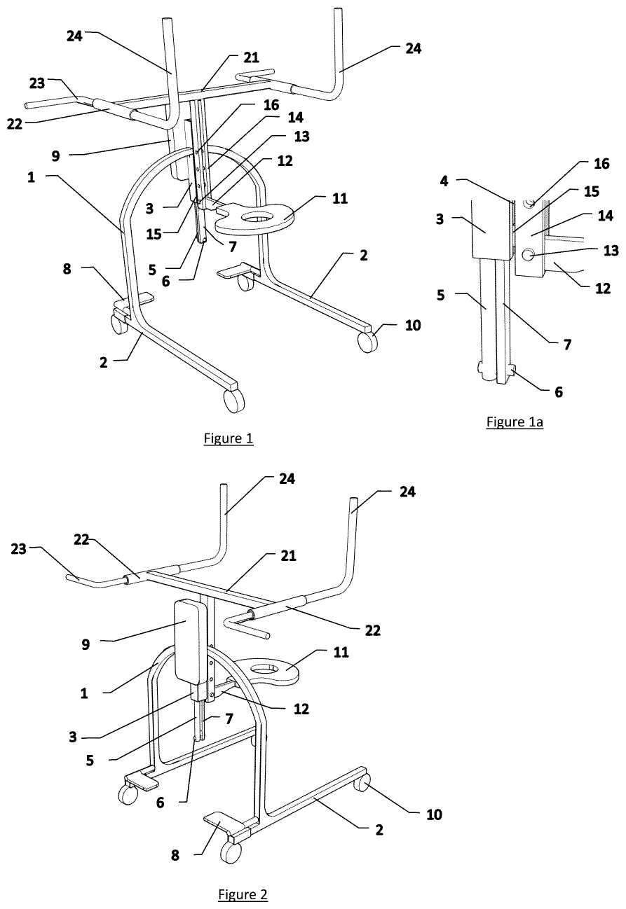

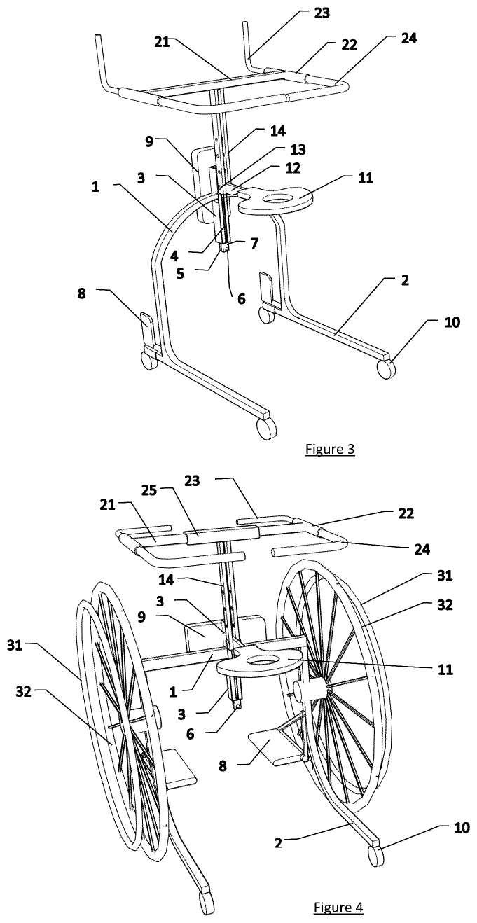

In FIGS. 1, la, 2 and 3, a preferred embodiment is disclosed. There are two main components to the walking frame: the main frame 1 and the seat 11. The components of the main frame 1 are wheelbases 2 with four wheels 10, a casing 3 and its encased height adjusting means (such as an actuator 5) and its corresponding pole 7, foot pedals 8 and a battery pack 9. The entire seat components (11 to 24) are connected to the main frame 1 through a vertical bar 14 at a connector 15 (FIG. 1a). The casing 3 has a long slit 4 posteriorly for the connector 15 to slide up and down. As both the actuator 5 and its pole 7 are joined 6 and encased in the casing 3, extending (FIGS. 1 and 2) and retracting (FIG. 3) the actuator 5 will move the pole 7, thereby the connector 15 and the seat components (11 to 24) accordingly. The vertical bar 14 comprises two brackets 24 at the top (connected through a transverse beam 21 and supporting tubes 22) and the seat 11 at the bottom (connected through the horizontal beam 12). The height between the two beams 21, 12 can be adjusted to suit the height of the user's torso by attaching 13 the horizontal beam 12 to an appropriate slot 16 on the vertical bar 14, so that the backrests 24 is at the level of upper lumbar to mid-thorax of the user. To allow the user to enter and exit the brackets 24 easily, the bracket 24 can be tilted open (FIGS. 1 and 2) by turning the handles 23 at the front. The brackets 24 may also be optionally opened (FIGS. 1 and 2) and closed (FIG. 3) by using other means, such as an electric motor.

In a typical scenario of using the present invention, the height between the upper transvers beam 21 and the lower horizontal beam 12 is first adjusted to match the torso of the user by attaching 13 the lower beam 12 to an appropriate slot 16 on the vertical bar 14 (FIG. 1a). With the brackets 24 opened (FIG. 1), the seat 11 is lowered onto the platform the user is sitting for him to approach the walking frame 1 from behind. The cantilever nature of seat 11 allows the wheelbase 2 to go beneath the user's platform and thus allows the seat 11 to overlap with the platform for a more secure transfer. Once he or she is seated on the seat 11, the brackets 24 are closed and the whole seat component is elevated by retracting the actuator 5 to stand the user up (FIG. 3). The user is then able to walk or sit securely, with the beam 12 in between his thighs, seat 11 at his buttock and the brackets 24 encircling his torso. The foot pedals 8 are flipped up (FIG. 3) during walking, and down (FIGS. 1 and 2) when seated. The process is reverse for the user when exiting from the walking frame.

The walking frame can be turned into a hybrid self-moving wheelchair by replacing the front wheels with wide radius wheels 32 with corresponding handrails 31 for the user to push it around (FIG. 4). Likewise, a motor with its controller can be added to the wheels for it to move around with the user seated and his or her feet rested on the foot pedals 8.

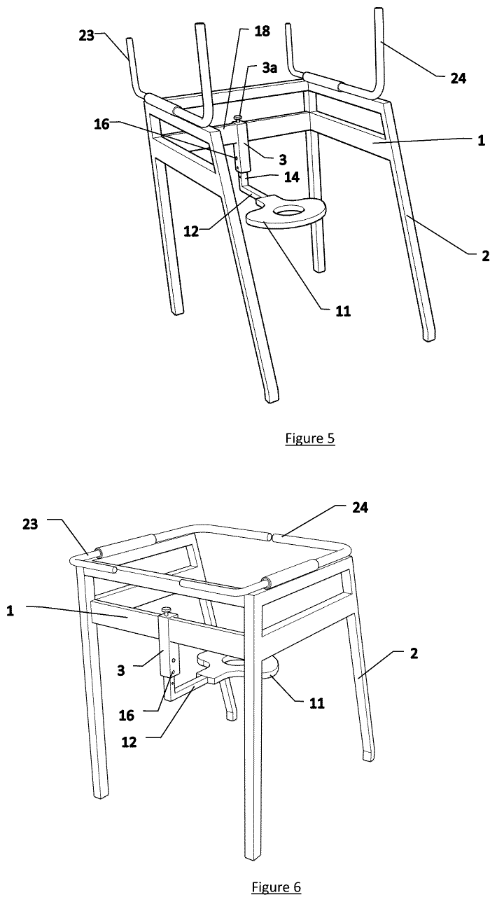

In another embodiment (FIGS. 5 and 6), the horizontal beam 12, the seat 11 and the brackets 24 can be added to a regular walking frame as accessories. The user only needs to attach the accessories to the front of the frame 18 by using a locking means 3a to turn the walking frame 1 into a sitting cum walking frame (FIGS. 5 and 6) that prevents accidental falls. The beam 12 may be supported by a vertical bar 14 wherein there are elongation means such as spaced slots 16 for the height adjustment of the seat 11 in relation to the backrest brackets 24, so that it can cater for torso lengths of different people as described above. Alternatively, the backrest 21 to 24 may be supported by the vertical bar 14 that is connected to the horizontal beam 12 as seen in the configuration of FIGS. 1 to 4.

In a separate embodiment, the seat 11 may be slidable along the beam 12 to suit users with different body builds. All the beams and brackets may have length adjustment means 25 (FIG. 4), such as telescopes, for the user to customize the frame dimensions to better secure him or her inside the frame 1 and brackets 24.

1. A walking frame comprising:
i. an anterior-posterior horizontal beam with one end attached to the frame, and the other end attached to a seat,
ii. a backrest comprising two side brackets that can be open or closed by rotating means.

2. As in claim 1, wherein the walking frame is in a cantilever configuration.

3. As in the claims above, wherein the walking frame is wheeled.

4. As in the claims above, the heights of the seat and the backrest are adjustable, by using a height adjusting means, to match the height of the platform the user is transferring to and fro.

5. As in the claims above, the height between the seat and the backrest is adjustable, by a height adjusting means, to accommodate the torso's height of the user.

6. As in the claims above, there in there is manual or motorised mobility aids on the wheels.
